(19) United States
(12) Patent Application Publication
(10) Pub. No.: US 2010/0051571 A1
(43) Pub. Date: Mar. 4, 2010

(54) Ratatable gantry

(75) Inventors: Pzung-Cheng Liou, Taichung City (TW); Don-Hua Cheng, Taichung City (TW)

Correspondence Address: CHARLES E. BAXLEY, ESQUIRE, 90 JOHN STREET, SUITE 309, NEW YORK, NY, 10038, US

(73) Assignee: Hiwin Mikrosystem Corp.

(21) Appl. No.: 12/231,102

(22) Filed: Aug. 28, 2008

(51) Int. Cl. B66C 11/10

(52) U.S. Cl. 212/317

(57) ABSTRACT

A rotatable gantry comprises an extendable transverse bridge that is horizontally rotatable and capable of changing its extending direction with respect to a base of the rotatable gantry so that the extendable transverse bridge can be rotated and contained within a width of the base of the rotatable gantry for convenient transportation.

### BACKGROUND OF THE INVENTION

1. Technical Field

The present invention relates to a machining center having a gantry that has an extendable and rotatable transverse bridge.

2. Description of Related Art

A conventional gantry machining center, as provided in FIGS. 1 and 2, comprises a base 10, a transverse bridge 11 that is mounted on the base 10 and reciprocates along a direction parallel to a Y-axis of the base 10, and a movable seat 12 that reciprocates along a direction parallel to an X-axis of the base 10. The movable seat 12 carries a tool serving to process workpieces and moves along the transverse bridge 11.

As can be seen in FIG. 3, a multi-tool gantry machining center has plural said movable seats 12 settled on the transverse bridge 11 for carrying different tools. Therein, for maintaining a constant travel length of each said movable seat 12, the transverse bridge 11 is preferably a transversely extendable one that is extendable along a direction parallel to the X-axis of the base for as to jut out one lateral of the base 10, thereby providing an extended overall width of the gantry.

However, when such a machining center having such extendable transverse bridge is to be transported between different sites, such as from a manufacturer to a user, with consideration of the road width, the transverse bridge 11 often has to be detached from the base 10 in transportation and reassembled to the base 10 after arriving the destined site. Consequently, while operations of reassembly and calibration can consume a lot of time, accuracy of the reassembly is unlikely ensured.

### SUMMARY OF THE INVENTION

One objective of the present invention is to provide a rotatable gantry with an extendable transverse bridge that is horizontally rotatable and thus capable of changing its extending direction so that the extendable transverse bridge can be rotated to not jut out a base of the gantry and an overall width of the gantry can be reduced for convenient transportation on narrow streets without having the extendable transverse bridge detached therefrom and moved separately. After the rotatable gantry is delivered to a destined site, as long as the extendable transverse bridge is horizontally rotated to return a working position, the rotatable gantry is ready to serve again. With the present invention, time and energy for detaching, reassembling and calibrating a transverse bridge that are consumed by the prior art devices can be saved.

A rotatable gantry comprises:

a base, having each side mounted with a mover moving along a direction parallel to a Y-axis of the base;

an extendable transverse bridge, parallel to an X-axis of the base and corresponding to an upper portion of the base, in which one end thereof extends beyond and juts out one of two opposite laterals of the base; and

a rotation device, connecting the extendable transverse bridge with the two movers so that the extendable transverse bridge pivoting on the rotation device horizontally rotate with respect to the X-axis and a predetermined included angle is formed between the extendable transverse bridge and the X-axis.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a front view of a conventional gantry machining center;

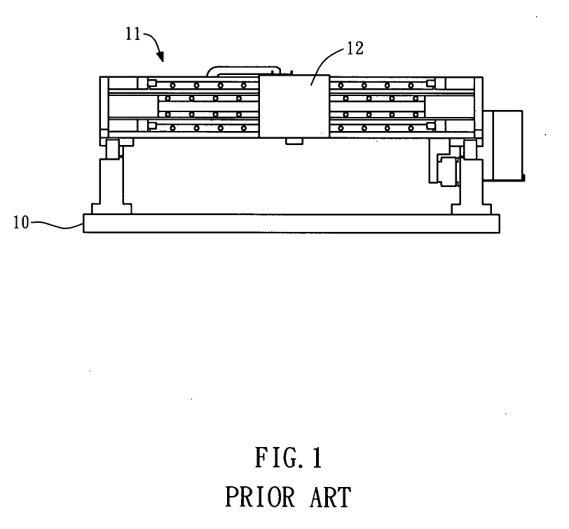

FIG. 2 is a top view of the conventional gantry machining center as shown in FIG. 1;

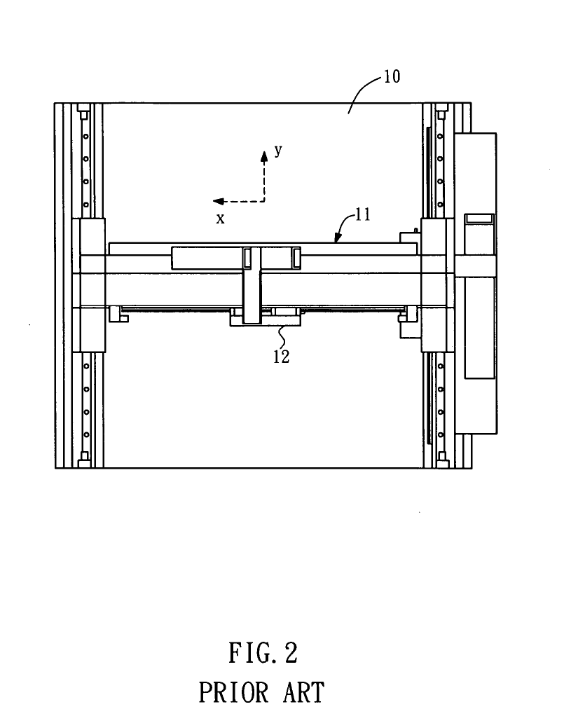

FIG. 3 is a front view of a known extendable gantry, wherein an extendable transverse bridge extends beyond one of two opposite laterals of a base along a direction parallel to an X-axis of the base;

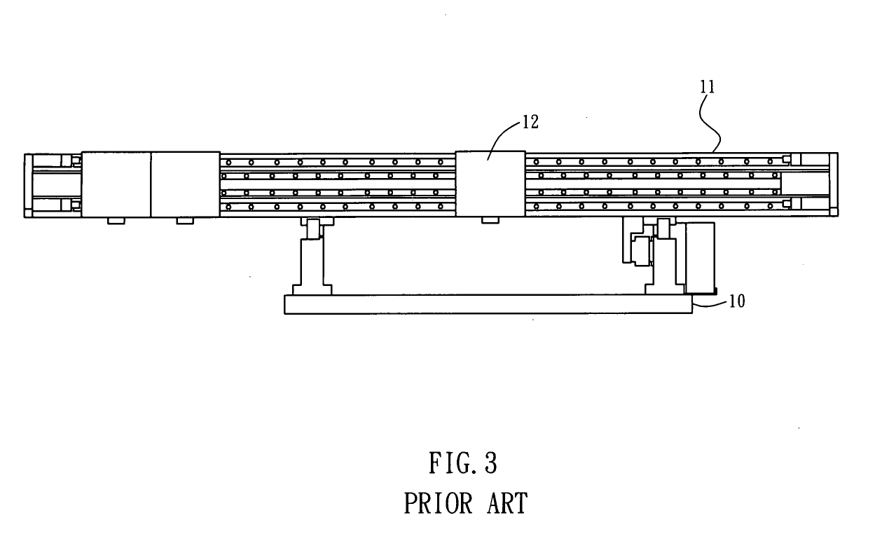

FIG. 4 is a front view of a rotatable gantry having an extendable transverse bridge according to the present invention;

FIG. 5 is a cross-sectional view of the rotatable gantry taken along line 5-5 of FIG. 4 and seeing along the adjacent arrow;

FIG. 6 is a cross-sectional view of the rotatable gantry taken along line 6-6 of FIG. 4 and seeing along the adjacent arrow;

FIG. 7 is a bottom view of the rotatable gantry seeing along Arrow 7 of FIG. 4; and

FIG. 8 is another bottom view of the rotatable gantry showing the extendable transverse bridge being horizontally rotated.

### DETAILED DESCRIPTION OF THE PREFERRED EMBODIMENTS

While a preferred embodiment is provided herein for illustrating the concept of the present invention as described above, it is to be understood that the components in these drawings are made for better explanation and need not to be made in scale. Moreover, in the following description, resemble components are indicated by the same numerals.

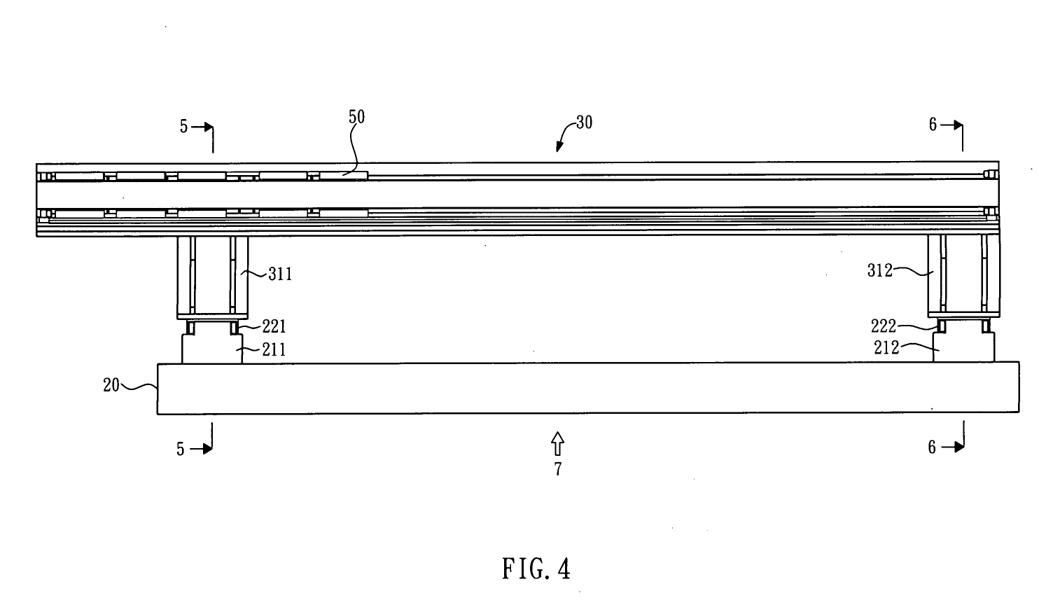

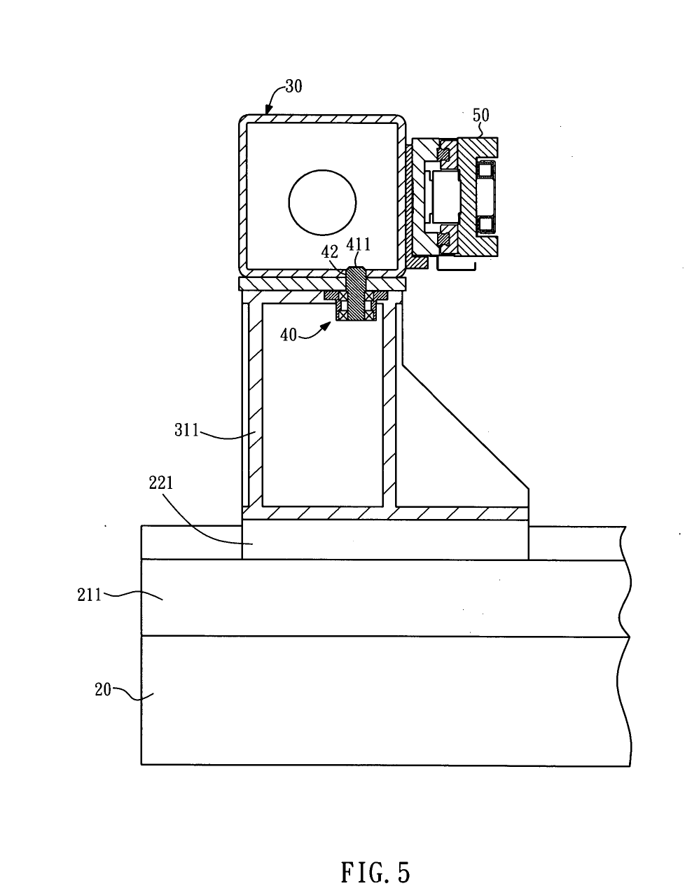

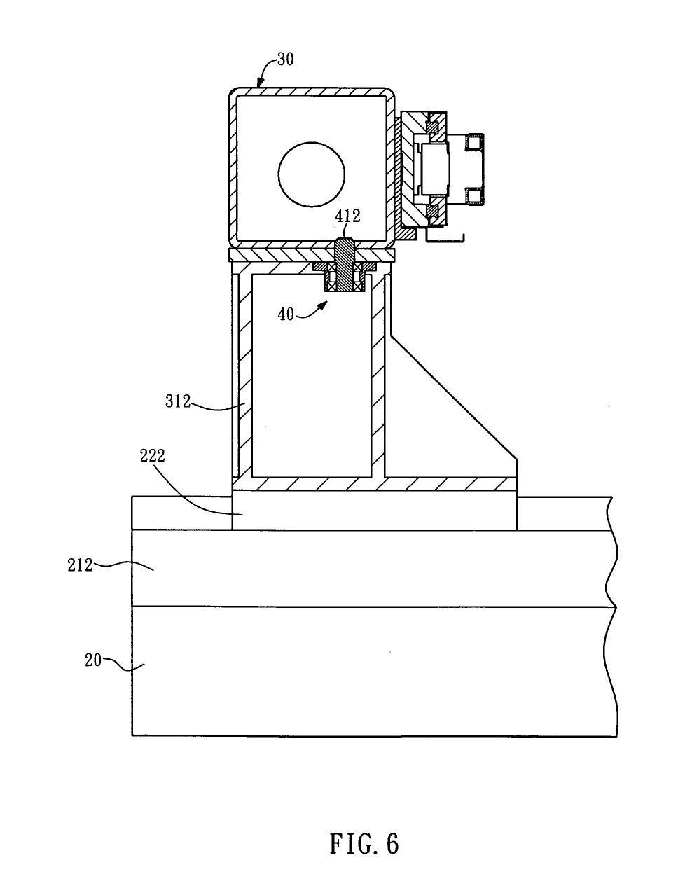

A rotatable gantry disclosed in the present invention can be seen in FIGS. 4, 5 and 6 and comprises a base 20, an extendable transverse bridge 30, and a rotation device 40.

The base 20 has each side of its top provided with a linear sliding rail 211, 212. Each of the linear sliding rails 211, 212 is mounted with a mover 221, 222.

The extendable transverse bridge 30 is connected with the two movers 221, 222 through two supporters 311, 312. The extendable transverse bridge 30 has an axial length greater than a width of the base 20 and extends along a direction parallel to an X-axis of the base 20 to jut out one of two opposite laterals of the base 20. A plurality of movable seats 50 are settled on the extendable transverse bridge 30.

The rotation device 40 comprises two rotation shafts 411, 412 and a linear receiving portion 42. The two rotation shafts 411, 412 pivotally connect a bottom of the extendable transverse bridge 30 with the two supporters 311, 312 while the linear receiving portion 42 is settled at the bottom of the extendable transverse bridge 30 and extends beyond the lateral of the base 20. The linear receiving portion 42 is parallel to an axis of the extendable transverse bridge 30 and is formed as a slot or a lengthwise groove for receiving an end of the corresponding rotation shaft 411.

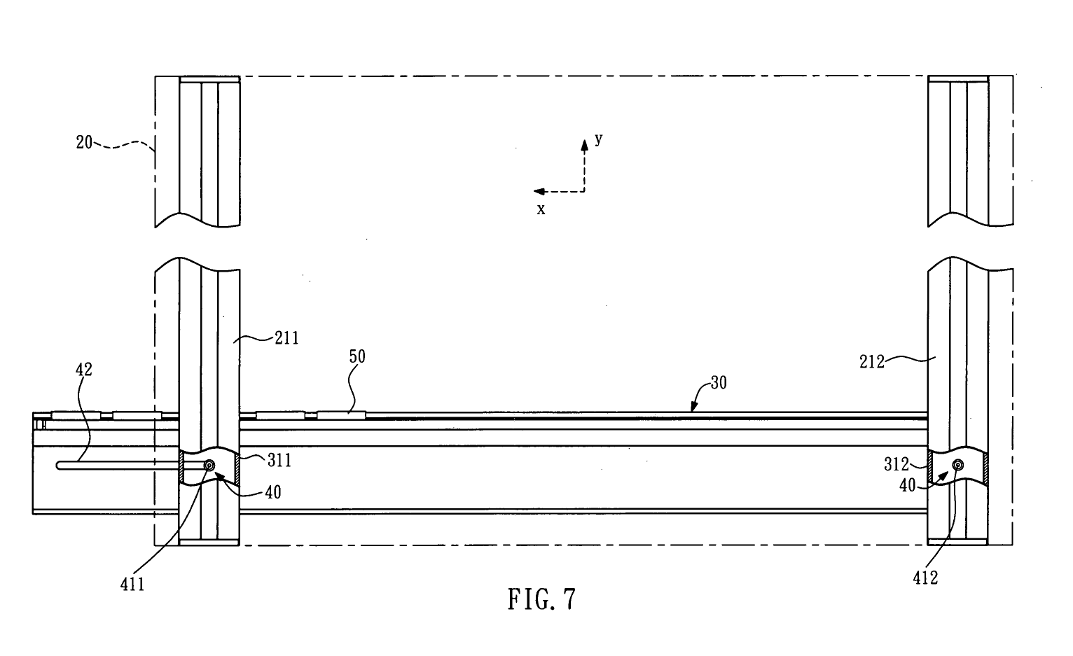

Referring to FIG. 7, the extendable transverse bridge 30 is parallel to the X-axis of the base 20 and can be driven by the movers 221, 222 to reciprocate along a Y-axis of the base 20.

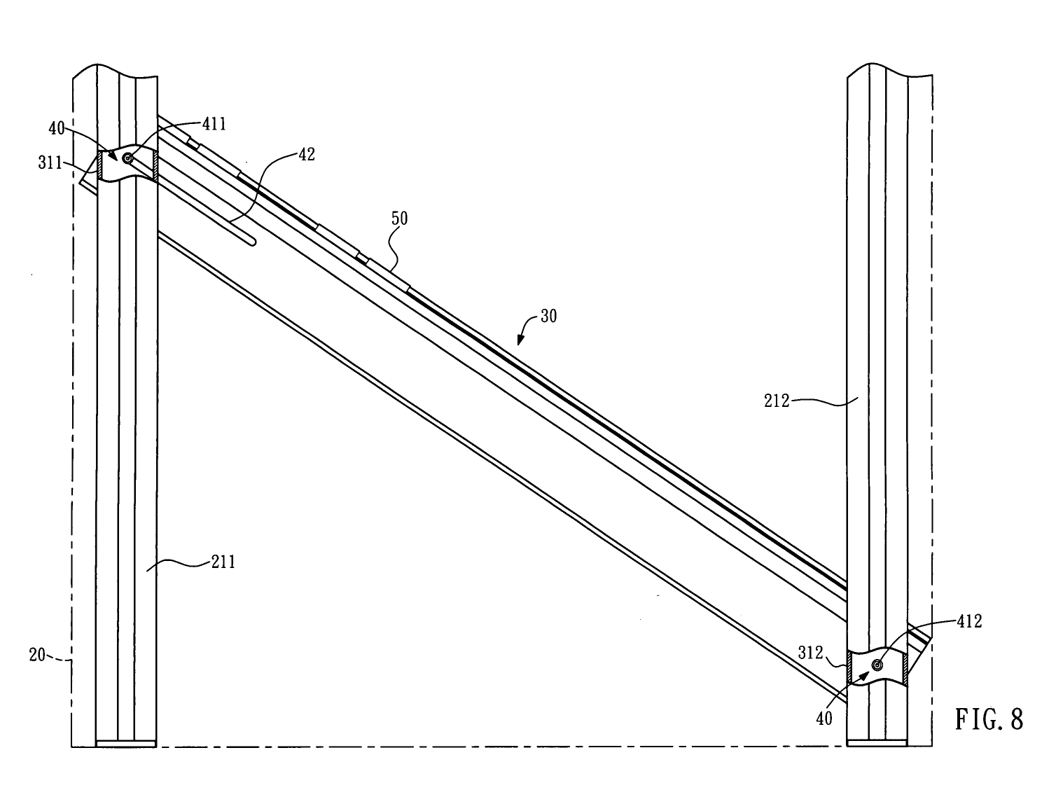

As shown in FIG. 8, when one said mover 221 moves along the corresponding linear sliding rail 211 for a predetermined distance, the extendable transverse bridge 30 has a corresponding end pivoting on the rotation shaft 412 so that the other mover 222 is moved and drives an opposite end, namely a moving end, of the extendable transverse bridge 30 to make the rotation shaft 411 at the moving end shift along the linear receiving portion 42. Thereupon, the extendable transverse bridge 30 is horizontally rotated and has its extending direction changed. When the rotatable gantry is to be transported, the extendable transverse bridge 30 can be rotated and contained within a width of the base 20 so as to reduce an overall width of the rotatable gantry for convenient transportation on narrow streets. After transportation, the extendable transverse bridge 30 can be easily horizontally rotated to a working position as shown in FIG. 7.

In virtue of the rotatability of the extendable transverse bridge 30, the gantry can transported without detaching the extendable transverse bridge 30 so that time and energy for detaching, reassembling and calibrating a transverse bridge that are consumed by the prior art devices can be saved. After the rotatable gantry is delivered to a destined site, as long as the extendable transverse bridge 30 is horizontally rotated to its initial working position, the rotatable gantry is ready to serve again.

Although the particular embodiment of the invention has been described in detail for purposes of illustration, it will be understood by one of ordinary skill in the art that numerous variations will be possible to the disclosed embodiment without going outside the scope of the invention as disclosed in the claims.

What is claimed is:

1. A rotatable gantry, comprising:
a base, having each of two sides thereof mounted with a mover moving along a direction parallel to a Y-axis of the base;
an extendable transverse bridge, parallel to an X-axis of the base and corresponding to an upper portion of the base, in which one end thereof extends beyond and juts out one of two opposite laterals of the base; and
a rotation device, connecting the extendable transverse bridge with the two movers in a manner that when the extendable transverse bridge pivots on the rotation device, the extendable transverse bridge horizontally rotates with respect to the X-axis so that a predetermined included angle is formed between the extendable transverse bridge and the X-axis.

2. The rotatable gantry of claim 1, wherein the rotation device comprises two rotation shafts and a linear receiving portion, in which the rotation shafts pivotally connect a bottom of the extendable transverse bridge with the two movers while the linear receiving portion is formed at the bottom of the extendable transverse bridge and extends beyond the lateral of the base, said linear receiving portion being parallel to an axis of the extendable transverse bridge for receiving an end of the corresponding rotation shaft.
